(19) United States
(12) Patent Application Publication
(10) Pub. No.: US 2003/0056010 A1
(43) Pub. Date: Mar. 20, 2003

(54) Downstream metadata altering

(75) Inventor: Peter Bernhard Kaars, Cupertino, CA (US)

Correspondence Address: Corporate Patent Counsel, U.S. Philips Corporation, 580 White Plains Road, Tarrytown, NY, 10591, US

(73) Assignee: KONINKLIJKE PHILIPS ELECTRONICS N.V.

(21) Appl. No.: 09/957,849

(22) Filed: Sep. 20, 2001

(51) Int. Cl. G06F 15/16

(52) U.S. Cl. 709/246

(57) ABSTRACT

A piece of content and an associated original metadata are received by a device. The original metadata may have been corrupted during delivery to the device or may be outdated. The device enables modifying the original metadata. The device comprises an identifier to determine identification data for a piece of content. The identification data may be a fingerprint generated from content. The identification data is used to access a record in a database associated with the piece of content. A processing unit of the device determines a new metadata from the accessed record. The device modifies the original metadata from the new metadata.

### FIELD OF THE INVENTION

The invention pertains to the processing of content and associated metadata. The invention is relevant to interactive content and A/V entertainment programs, to which complementary information-rich data was added.

### BACKGROUND

Personal audio and video entertainment services allow coupling audio/video content with additional information-rich data. The information-rich data is hereafter referred to as metadata, the metadata being, by definition, data about corresponding audio/video content. The metadata is either sent with corresponding audio/video content or separately from content through a different communication channel or at a different period in time. For example, an electronic program guide (EPG) may comprise metadata related to an A/V program that is or will be broadcast to the end-user. The metadata comprises, for example, a short description of the video/audio program, the casting, key scenes, or the scheduled time of broadcast.

Various technologies and standards have been developed to enable the addition of data about an A/V program in the program itself. Closed Captioning is one of them. In broadcast and cable television, Closed Captioning refers to the insertion, into the blank lines between frames, of information that may be decoded and displayed on the screen. The information is displayed as written words corresponding to those being spoken. Closed Captioning was initially developed for the hearing-impaired and requires a special decoder, which may be external to or built into the television receiver. Similarly, the Teletext system, which is prevalent in Europe, adds data to a broadcast program in the vertical blanking period. The user accesses this data by tuning to the proper channel via a Teletext decoder. Like Closed Captioning data, Teletext data is structured for display purposes and is not in a structured form that facilitates access to alternative sources of information.

Reference is made to U.S. Patent Application “Broadcast and processing of meta-information associated with content material”, Ser. No. 09/789,906 (Attorney docket US018019) of the same Assignee, incorporated herein by reference. This application proposes a possible application for metadata. This document discloses meta-information included with the broadcast of content material. The meta-information contains information for accessing available content material, and contains characterizing information related to the material. A processing device at the user's broadcast receiver is configured to process this information-rich meta-information corresponding to a large volume of available content material to facilitate filtering of the available material, or automating or optimizing the selection process.

### SUMMARY

It is an object of the invention to provide a device that permits modifying an original set of metadata related to a received piece of content.

To this end, a device of the invention comprises identifying means for determining identification data identifying the piece of content. Then, a retrieving means uses the identification data to access a record stored in a database. A new set of metadata is determined from the record. Then, further means alters the original set of metadata from the new set of metadata.

When located at the end-user's side, a device of the invention allows a service provider to modify the original set of metadata downstream, i.e. once the piece of content has arrived at its final destination. In the invention, metadata refers to structured data about the piece of content. The inventor has realized that the received original set of metadata may have been corrupted during delivery to the individual. Alternatively, the original set of metadata may be outdated or needs to be adapted to a specific application, for which the metadata and content will be used. Thus, the device allows replacing the original set of metadata with a new set of metadata. The new set is determined from a record in a database. The record may be indexed in the database using identification data specific to the piece of content. The device determines the identification data and from there, accesses the record. The identification data is, for example, a characteristic pattern or a fingerprint of the piece of content. The new set is either stored in the record or generated based on information stored in the record. The original set may comprise templates or blank fields that the device fills up through lookup in the database when receiving or playing out the piece of content.

In an embodiment, the new set of metadata may also be determined based on the individual's identity or a profile built for the individual or the device. An advantage of the invention is to permit the content provider to refine a personalization of delivered content to improve the customer satisfaction. Enabling to modify the metadata downstream also permits the service provider to deliver better targeted content and associated information.

### BRIEF DESCRIPTION OF THE DRAWING

The invention is explained in further details, by way of examples, and with reference to the accompanying drawing wherein:

FIG. 1 is a communication system with a device of the invention.

Elements within the drawing having similar or corresponding features are identified by like reference numerals.

### DETAILED DESCRIPTION

The invention relates to the processing of content and associated metadata. The invention pertains to any type of multimedia content, e.g., textual, audio, video or audio/video such as a movie segment, a song, a radio or television program, a Web page, a portion of an electronic program guide or combination thereof. Although the embodiments described herein are given in the framework of personal television services such as the ones offered by TIVO or MICROSOFT, the invention is also applicable to various other content distribution models. For example, the invention is also relevant to inter or intra-company file sharing, communications transfer in a home network, public information distribution, information retrieval such as in libraries or multimedia files streaming and downloading over the Internet.

Linguistically, the term metadata refers to “data about data”. As used herein, metadata includes data related to the piece of content and conveyed in a structured form that an appropriate device can understand. Metadata can refer to descriptive information. The metadata can be transmitted along with and coupled with the piece of content or the metadata can be transmitted in a different stream of data before or after the piece of content is transmitted.

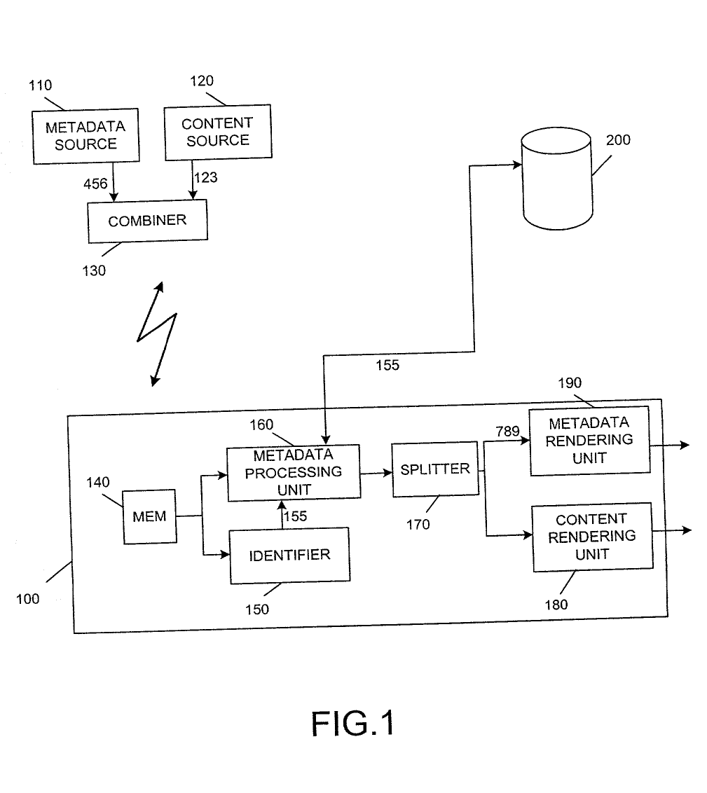

FIG. 1 illustrates a content delivery system including a device 100 of the invention. In this delivery system, a piece of content 123 with embedded set of metadata 456 is broadcast to the device 100. Broadcastings refers to any method of conveying information without a specific identification of the intended recipient or without regard for whether an identified recipient actually receives the conveyed information. A combiner 130 combines the original metadata 456 and content 123, received from respective metadata source 110 and content source 120, into one stream of data broadcast to the device 100. In another embodiment, content 123 and metadata 456 are conveyed separately to the device 100, either via different communication channels or at different moments in time.

It is to be noted that the invention encompasses various transmission technologies other than broadcast taken only as an example in this embodiment. Content 123 and the original metadata 456 may also be unicast, i.e. transmitted to one specific receiver, the device 100, or multicast, i.e. transmitted to multiple receivers. In another embodiment, content 123 and the metadata 456 are downloaded or streamed over the Internet to the device 100. In streaming technologies, the multimedia file is continuously transmitted and is played out as soon as it arrives whereas, in downloading technologies, a user needs to wait until the entire file has been received before playing it. In yet another embodiment, content 123 and the associated metadata 456 are transmitted via a peer-to-peer configuration. In a peer-to-peer model, each party has the same capability and either party can initiate a communication path. Such a configuration is commonly encountered in file sharing over the Internet or in file sharing within a private or corporate network.

The device 100 comprises a memory 140, a metadata processing unit 160, an identifier 150, a splitter 170, a metadata rendering unit 190 and a content rendering unit 180. The device 100 stores received content 123 and original metadata 456 in memory 140. In this embodiment, content 123 and metadata 456 received as one stream of data, e.g. metadata 456 and content 123 are interleaved, and content 123 and metadata 456 are stored as such in memory 140. In another embodiment, content 123 and metadata 456 are separated and stored in different memory partitions of memory 140. The memory 140 may also be used as a buffer.

The identifier 150 determines an identification data 155 from content 123 with the identification data 155 enabling identifying content 123. The identification data 155 is possibly a fingerprint derived from content 123. The identifier 150 may generate the identification data 155 internally from stored content 123. For example, the identifier 150 computes the data 155 using well-known in the art hash algorithms. Alternatively, the identification data 155 may have been embedded in received content 123 in a format that the identifier 150 can understand before transmission to the device 110. The identification data 155 may have been previously generated and embedded in content 123 at the content source 120. Reference is made to U.S. Patent Application “Enhanced watermark computing method”, Ser. No. 09/898,248 (attorney docket US018084), incorporated herein by reference. This document discloses a method of computing a watermark for a piece of content on the basis of a characteristic pattern derived from the piece of content. Such a watermark may contain the characteristic pattern derived for the piece of content.

A database 200 comprises records associated with respective pieces of content. The metadata processing unit 160 accesses a record in the database 200 associated with content 123 using the identification data 155. Each record in the database 200 may comprise a short description of the associated piece of content, biographies of the cast, duration of the piece of content, time reference along the piece of content, references to other pieces of content, key scenes and so on. In an embodiment, records for respective pieces of content are indexed with respective identification data derived from the respective piece of content. This identification data may be in the same format as the identification data 155. Thus, the unit 160 can retrieve a specific record associated with content 123 using the identification data 155.

The unit 160 determines a new set of metadata 789 from the accessed record associated with content 123. The new metadata 789 may be generated by a processing arrangement at the database 200 or the new metadata 789 may be generated internally in the device 100 by the unit 160. The metadata 789 may be extracted as such from the record or may be inferred from information present in the record.

In an example embodiment of the invention, the metadata 789 is further determined from a profile of the user of the device 110. The profile is either expressly built by the user or implicitly based on statistics on the user's behavior and tastes, features of the device 100 or geographical location of the user.

In yet another embodiment of the invention, the metadata 789 is further determined based on characteristics of a specific application, for which content 123 is intended to be used. Indeed, content 123 may be used for different applications. For example, on one hand, a cartoon program may be played out as such with the only purpose to entertain children. On the other hand, the same cartoon program may also be played out for education purposes, e.g. reading teaching. A first set of metadata comprising key scene descriptions, characters' identifiers may be associated to the program when the cartoon program is simply played out to the children. A second different set of metadata comprising for example names of objects shown in the cartoon may be associated with the cartoon so that the name of an object can be displayed next to the object when the object is selected on the screen. In this example, the proper set of metadata is associated with the cartoon depending on the application of the cartoon.

In the invention, the metadata 789 is used to replace the metadata 456. The need for replacing the metadata 456 with the new metadata 789 may be due to various reasons. First, the metadata 456 may have been corrupted during transfer to the device 100 and the metadata 789 can therefore be an intact version of the metadata 456. Second, the metadata 456 may be outdated and needs to be replaced with the new metadata 789 comprising up-to-date information with respect to content 123. For example, considering an audio MPEG-1 layer 3 encoded content 123, the metadata 789 could give, e.g. the latest news concerning the artists, their latest concerts, their albums releases and the titles of the albums containing content 123. Furthermore, the metadata 456 may be a structured blank field that is filled up from the metadata 789.

The unit 160 replaces the metadata 456 associated with content 123 with the new metadata 789. The unit 160 may store content 123 with new metadata 789 in the memory 140 thereby replacing content 123 previously stored with the metadata 456. The metadata 456 possibly represents information in a structured format with blank fields to be filled up with the relevant information. The metadata 456 may also be constructed as a template with pointers that needs to be modified or updated. The unit 160 generates the metadata 789 by filling up the blank fields or by updating the pointers in the template with data obtained from the database 200. The metadata 456 and 789 may be information encoded using a markup language format, e.g. HTML (Hypertext Markup Language) or XML (Extended Markup Language). For example, the Standard Generalized Markup Language (SGML) specifies a system indicating how to insert symbols in a document and how to tag elements in the document. Such symbols can indicate where to place elements when displaying the document or how to format a specific element in the document to enable the display of the element based on the available displaying capacities.

In another example embodiment of the invention, the metadata 456 and 789 are descriptive information encoded using the MPEG-7 standard. The MPEG-7 standard has been developed on top of other existing MPEG standards without substituting for them. MPEG-7 aims at offering a comprehensive set of audio and visual descriptions of content. MPEG-7 enables various applications to be performed on content ranging from accurate and personalized filtering, search and retrieval to content identification. In this example, content 123 is either an analog stream or any type of digitally encoded data stream. According to the MPEG-7 standard, the metadata 456 and 789 may comprise information on the creation and productions processes of content 123, e.g. director or title, information on the storage features of the content such as storage format or encoding format, and, information related to the usage of the content, e.g. copyrights and usage history. The metadata 456 and 789 may also contain structural information on spatial and temporal characteristics of content 123, e.g. scene cuts, segmentation in regions, key scenes.

The splitter 170 separates the metadata 789 from content 123 respectively supplied to the unit 190 and the unit 180. The metadata rendering unit 190 processes metadata 789 and enables rendering metadata 789, thereby enabling interactive applications performed with content 123. The unit 180 renders content 123 to the user.

An advantage of one or more embodiments of the invention is to ensure the quality of information that can be associated with content 123. Indeed, by enabling the individual to arbitrarily modify the original set of metadata 456, the individual is able to choose the information that accompanies content 123. The individual is not forced to keep the full set of metadata 456 that a content provider originally incorporated in content 123 or at least associated with content 123.

It is to be noted that the configuration of the device 100 given in FIG. 1 is only given here as an example. Other configurations of the device 100 allowing to replace the metadata 456 according to the invention are also within the scope of the invention. For example, the device 100 may not necessarily comprise a memory unit 140 and processing of content 123 and the metadata 456 can be performed in real time when the data is received. Besides, if the device 100 receives content 123 and the metadata 456 coupled in one stream, the splitter 170 may be located at the reception end and separates the two streams before any further processing. It is also within the scope of the invention to consider a configuration of the device 110, wherein the metadata 789 is not inserted into content 123 but kept separate. In this embodiment, the metadata 789 replaces the metadata 456 in memory 140.

It is to be noted that the word “comprising” does not exclude the presence of other elements.

I claim:

1. A device for altering an original set of metadata associated with a received piece of content, the device comprising:
identifying means for determining identification data identifying the piece of content;
processing means for determining, based on the identification data, a new set of metadata from a database of records associated with respective pieces of content; and,
means for altering the original set of metadata from the new set of metadata.

2. The device of claim 1, wherein the altering means replaces the original set of metadata with the new set of metadata

3. The device of claim 1, wherein the new set of metadata is further determined based on a profile of a user of the device.

4. The device of claim 1, wherein the original and new sets of metadata are in a structured format.

5. The device of claim 1, wherein the original set of metadata comprises at least one blank field and the altering means fills up the blank field from the new set of metadata.

6. The device of claim 1, wherein the original and new sets of metadata are encoded using a markup language format.

7. The device of claim 1, wherein the original and new sets of metadata are encoded using the MPEG-7 standard.

8. The device of claim 1, wherein the identification data is one of a characteristic pattern, a hash pattern or a fingerprint.

9. The device of claim 1, wherein the original set of metadata is corrupted.

10. The device of claim 1, wherein the original set of metadata is timely outdated.

11. The device of claim 1, wherein the new set of metadata is determined based on an application, for which the piece of content is intended.

12. The device of claim 1, wherein the processing means accesses a record associated with the piece of content using the identification data and wherein the processing means generates the new set of metadata based on information stored in the record.

13. The device of claim 1, wherein the processing means accesses a record associated with the piece of content using the identification data and wherein the processing means retrieves the new set of metadata from a record associated with the piece of content.

14. A circuit arrangement for altering an original set of metadata associated with a received piece of content, the circuit comprising:
an identifying arrangement for determining identification data identifying the piece of content;
a processing arrangement for determining, based on the identification data, a new set of metadata from a database of records associated with respective pieces of content;
an arrangement for altering the original set of metadata from the new set of metadata.

15. A software application including instructions for enabling altering a set of metadata associated with a piece of content, the method comprising:
determining an identification data identifying the piece of content;
determining, on the basis of the identification data, a new set of metadata from database of records associated with respective pieces of content;
altering the original set of metadata from the new set of metadata.
